(19) United States
(12) Patent Application Publication
(10) Pub. No.: US 2017/0275209 A1
(43) Pub. Date: Sep. 28, 2017

(54) ADDITION OF MINERAL-CONTAINING SLURRY FOR PROPPANT FORMATION

(71) Applicant: Imerys Oilfield Minerals, Inc., Roswell, GA (US)

(72) Inventors: Mark WINDEBANK, Milledgeville, GA (US); Johan LORICOURT, Villach (AT)

(21) Appl. No.: 15/512,087

(22) PCT Filed: Sep. 18, 2015
(86) PCT No.: PCT/US15/50855

§ 371 Date: Mar. 17, 2017

Related U.S. Application Data
(60) Provisional application No. 62/052,541, filed on Sep. 19, 2014.

(51) Int. Cl. C04B 35/626; C04B 35/622; C09K 8/80; C04B 33/04

(52) U.S. Cl. CPC C04B 35/6263; C04B 33/04; C04B 35/62204; C09K 8/805; C04B 2235/5296

(57) ABSTRACT

A method of making a proppant may include adding a dry ceramic precursor to a granulator, adding a slurry to the granulator, granulating the dry ceramic precursor and the slurry to form densified granules, and firing the densified granules to form a ceramic proppant. The dry ceramic precursor may include an alumina- or aluminosilicate-containing material, such as, for example, at least one of kaolin, ball clay, bauxitic kaolin, smectite clay, bauxite, gibbsite, boehmite, metakaolin, or diaspora. The slurry may include a recycled proppant material, such as, a fired recycled proppant material or a green recycled proppant material.

### CLAIM FOR PRIORITY

This PCT International Application claims the benefit of priority of U.S. Provisional Patent Application No. 62/052,541, filed Sep. 19, 2014, the subject matter of which is incorporated herein by reference in its entirety.

### DESCRIPTION

Field of the Disclosure

The present disclosure relates to methods of making and using proppants for fractured earth having a high compressive strength combined with good conductivity. It also relates to methods of making and using anti-flowback additives for use in fracturing operations.

Background of the Disclosure

Naturally occurring deposits containing oil and natural gas have been located throughout the world. Given the porous and permeable nature of the subterranean structure, it is possible to bore into the earth and set up a well where oil and natural gas are pumped out of the deposit. These wells are large, costly structures that are typically fixed at one location. As is often the case, a well may initially be very productive, with the oil and natural gas being pumpable with relative ease. As the oil or natural gas near the well bore is removed from the deposit, other oil and natural gas may flow to the area near the well bore so that it may be pumped as well. However, as a well ages, and sometimes merely as a consequence of the subterranean geology surrounding the well bore, the more remote oil and natural gas may have difficulty flowing to the well bore, thereby reducing the productivity of the well.

To address this problem and to increase the flow of oil and natural gas to the well bore, companies have employed the well-known technique of fracturing the subterranean area around the well to create more paths for the oil and natural gas to flow toward the well. As described in more detail in the literature, this fracturing is accomplished by hydraulically injecting a fluid at very high pressure into the area surrounding the well bore. This fluid must then be removed from the fracture to the extent possible to ensure that it does not impede the flow of oil or natural gas back to the well bore. Once the fluid is removed, the fractures have a tendency to collapse due to the high compaction pressures experienced at well-depths, which can be more than 20,000 feet. To prevent the fractures from closing, it is well-known to include a propping agent, also known as a proppant, in the fracturing fluid. The goal is to be able to remove as much of the injection fluid as possible while leaving the proppant behind to keep the fractures open. As used in this application, the term “proppant” refers to any non-liquid material that is present in a proppant pack and provides structural support in a propped fracture. “Anti-flowback additive” refers to any material that is present in a proppant pack and reduces the flowback of proppant particles but still allows for production of oil at sufficient rates. The terms “proppant” and “anti-flowback additive” are not necessarily mutually exclusive, so a single particle type may meet both definitions. For example, a particle may provide structural support in a fracture and it may also be shaped to have anti-flowback properties, allowing it to meet both definitions.

Several properties affect the desirability of a proppant. For example, for use in deep wells or wells whose formation forces are high, proppants must be capable of withstanding high compressive forces, often greater than 10,000 pounds per square inch (“psi”). Proppants able to withstand these forces (e.g., up to and greater than 10,000 psi) are referred to as high strength proppants. If forces in a fracture are too high for a given proppant, the proppant will crush and collapse, and then no longer have a sufficient permeability to allow the proper flow of oil or natural gas. Other applications, such as for use in shallower wells, do not demand the same strength proppant, allowing intermediate strength proppants to suffice. These intermediate strength proppants are typically used where the compressive forces are between 5,000 and 10,000 psi. Still other proppants can be used for applications where the compressive forces are low.

In addition to the strength of the proppant, one must consider how the proppant will pack with other proppant particles and the surrounding geological features, as the nature of the packing can impact the flow of the oil and natural gas through the fractures. For example, if the proppant particles become too tightly packed, they may actually inhibit the flow of the oil or natural gas rather than increase it.

The nature of the packing also has an effect on the overall turbulence generated through the fractures. Too much turbulence can increase the flowback of the proppant particles from the fractures toward the well bore. This may undesirably decrease the flow of oil and natural gas, contaminate the well, cause abrasion to the equipment in the well, and increase the production cost as the proppants that flow back toward the well must be removed from the oil and gas.

To avoid a proppant that becomes too tightly packed or disrupting the flow in a fracture, green or sintered proppant particles may be screened during processing to achieve the desired—usually narrow—size distribution of granules or particles. The resulting oversized and undersized granules may be discarded, resulting in inefficient use of the green or sintered proppant materials.

The useful life of the well may also be shortened if the proppant particles break down. For this reason, proppants have conventionally been designed to minimize breaking. For example, U.S. Pat. No. 3,497,008 to Graham et al. discloses a preferred proppant composition of a hard glass that has decreased surface flaws to prevent failure at those flaws. It also discloses that the hard glass should have a good resistance to impact abrasion, which serves to prevent surface flaws from occurring in the first place. These features have conventionally been deemed necessary to avoid breaking, which creates undesirable fines within the fracture.

The shape of the proppant has a significant impact on how it packs with other proppant particles and the surrounding area. Thus, the shape of the proppant can significantly alter the permeability and conductivity of a proppant pack in a fracture. Different shapes of the same material offer different strengths and resistance to closure stress. It is desirable to engineer the shape of the proppant to provide high strength and a packing tendency that will increase the flow of oil or natural gas. The optimum shape may differ for different depths, closure stresses, geologies of the surrounding earth, and materials to be extracted.

Another property that impacts a proppant's utility is how quickly it settles both in the injection fluid and once it is in the fracture. A proppant that quickly settles may not reach the desired propping location in the fracture, resulting in a low level of proppants in the desired fracture locations, such as high or deep enough in the fracture to maximize the presence of the proppant in the pay zone (i.e., the zone in which oil or natural gas flows back to the well). This can cause reduced efficacy of the fracturing operation. Ideally, a proppant disperses equally throughout all portions of the fracture. Gravity works against this ideal, pulling particles toward the bottom of the fracture. However, proppants with properly engineered densities and shapes may settle more slowly, thereby increasing the functional propped area of the fracture. How quickly a proppant settles is determined in large part by its specific gravity. Engineering the specific gravity of the proppant for various applications is desirable because an optimized specific gravity allows a proppant user to better place the proppant within the fracture.

Yet another attribute to consider in designing a proppant is its acid-tolerance, as acids are often used in oil and natural gas wells and may undesirably alter the properties of the proppant. For example, hydrofluoric acid is commonly used to treat oil wells, making a proppant's resistance to that acid of high importance.

Still another property to consider for a proppant is its surface texture. A surface texture that enhances, or at least does not inhibit, the conductivity of the oil or gas through the fractures is desirable. Smoother surfaces offer certain advantages over rough surfaces, such as reduced tool wear and a better conductivity, but porous surfaces may still be desirable for some applications where a reduced density may be useful.

All of these properties, some of which can at times conflict with each other, must be weighed in determining the right proppant for a particular situation. Because stimulation of a well through fracturing is by far the most expensive operation over the life of the well, one must also consider the economics. Proppants are typically used in large quantities, making them a large part of the cost.

Attempts have been made to optimize proppants and methods of using them. Suggested materials for proppants include sand, glass beads, ceramic pellets, and portions of walnuts. The preferred material disclosed in previously-mentioned U.S. Pat. No. 3,497,008 is a hard glass, but it also mentions that sintered alumina, steatite, and mullite could be used. Conventional belief is that alumina adds strength to a proppant, so many early proppants were made of high-alumina materials, such as bauxite. The strength of these high-alumina materials is believed to be due to the mechanical properties of the dense ceramic materials therein. See, e.g., U.S. Pat. Nos. 4,068,718 and 4,427,068, both of which disclose proppants made with bauxite.

Bauxite is a natural mineral comprising various amounts of four primary oxides: alumina (Al₂O₃, typically from about 80% to about 90% by weight), silica (SiO₂, typically from about 1% to about 12% by weight), iron oxide (Fe₂O₃, typically from about 1% to about 15% by weight), and titania (TiO₂, typically from about 1% to about 5% by weight). After calcining or sintering, bauxite is known to have a higher toughness but a lower hardness than technical grade alumina-based ceramics. Since toughness is a primary mechanical characteristic to consider in improving the crush resistance or compressive strength of ceramics, bauxite is of interest for use in proppants. The microstructure of bauxite is characterized primarily by three phases: 1) a matrix of fine alumina crystal; 2) a titania phase where titania is complexed with alumina to form aluminum titanate (Al₂TiO₅); and 3) a mullite phase (3Al₂O₃, 2SiO₂). For the first two phases a partial substitution of aluminum by iron atoms is possible. To achieve good mechanical characteristics as a proppant, bauxite with lower levels of silica and iron oxide are preferred.

Today, as resources become more scarce, the search for oil and gas involves penetration into deeper geological formations, and the recovery of the raw materials becomes increasingly difficult. Therefore, it may be desirable to provide proppants and anti-flowback additives that have an excellent conductivity and permeability even under extreme conditions. It may also be desirable to provide an improved manufacturing process to improve the efficiency by which proppants and anti-flowback additives are made. It may also be desirable to improve the efficiency of manufacturing proppants and anti-flowback additives while improving the mechanical properties of the proppants and anti-flowback additives. It may also be desirable to provide proppants and anti-flowback additives that will reduce the cost of production and increase the useful life of the well.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary. Although certain aspects and embodiments may be discussed in terms of proppants, it is understood that the methods and disclosure provided are also applicable to anti-flowback additives.

According to one aspect of this disclosure, a method of making a proppant may include adding a dry ceramic precursor to a granulator, adding a slurry to the granulator, granulating the dry ceramic precursor and the slurry to form densified granules, and firing the densified granules to form a ceramic proppant.

According to another aspect, the dry ceramic precursor may include an alumina- or aluminosilicate-containing material, such as, for example, at least one of kaolin, ball clay, bauxitic kaolin, smectite clay, bauxite, gibbsite, boehmite, metakaolin, or diaspora.

According to another aspect, the slurry may include a recycled proppant material. For example, the recycled proppant material may include a fired recycled proppant material, a green recycled proppant material, or a combination thereof. According to another aspect, the recycled proppant material may include oversized particles and/or undersized particles.

It is to be understood that both the foregoing general description and the following detailed description are exemplary and explanatory only and are not restrictive of the invention, as claimed.

### BRIEF DESCRIPTION OF THE DRAWINGS

FIG. 1 shows an exemplary proppant prepared by adding an exemplary slurry to a dry ceramic precursor.

FIG. 2 shows an exemplary proppant particle prepared by adding an exemplary slurry to a dry ceramic precursor.

### DESCRIPTION OF EXEMPLARY EMBODIMENTS

Reference will now be made in detail to exemplary embodiments. Although certain examples or embodiments may be discussed in terms proppants, it is understood that these discussions are merely to facilitate clarity of the description and are exemplary only. The methods and compositions described in this disclosure are also applicable to, for example, anti-flowback additives.

According to some embodiments of this disclosure, a method of making a proppant may include adding a dry ceramic precursor to a granulator, adding a slurry to the granulator, granulating the dry ceramic precursor and the slurry to form densified granules, and firing the densified granules to form a ceramic proppant.

According to some embodiments, the dry ceramic precursor may include an alumina- or aluminosilicate-containing material. The alumina- or aluminosilicate-containing material may include at least one of kaolin, ball clay, bauxitic kaolin, smectite clay, bauxite, gibbsite, boehmite, metakaolin, or diaspora.

Although certain embodiments may be described in terms of kaolin or metakaolin as an alumina- or aluminosilicate-containing material, it is understood that these discussions are merely to facilitate description and are exemplary only. Similarly, although the ceramic precursor may be discussed in terms of an alumina- or aluminosilicate-containing material, other ceramic precursors may be used.

Kaolin is a common component in manufacturing for proppants for medium to deep hydraulic fracture treatments. Kaolin is sometimes referred to as china clay or hydrous kaolin, and contains predominantly the mineral kaolinite, together with small concentrations of various other minerals. Kaolinite may also be generally described as an aluminosilicate, aluminosilicate clay, or hydrous aluminosilicate (e.g., Al₂Si₂O₅(OH)₄).

Kaolin clays were formed in geological times by the weathering of the feldspar component of granite. Primary kaolin clays are those which are found in deposits at the site at which they were formed, such as those obtained from deposits in South West England, France, Germany, Spain, and the Czech Republic. Sedimentary kaolin clays are those which were flushed out from the granite matrix at their formation site and were deposited in an area remote from their formation site, such as in a basin formed in the surrounding strata.

Metakaolin is a form of calcined kaolin. Calcined kaolins are kaolins that have been converted from the corresponding (naturally occurring) hydrous kaolin to the dehydroxylated form by thermal methods. Calcination changes at least some of the kaolin structure from crystalline to amorphous. The degree to which hydrous kaolin undergoes changes in crystalline form may depend on the amount of heat to which it is subjected. Initially, dehydroxylation of the hydrous kaolin occurs on exposure to heat. At temperatures below about 850-900° C., the kaolin may be considered to be virtually dehydroxylated with the resultant amorphous structure commonly being referred to as being a metakaolin. Calcination in this temperature range may be referred to as partial calcination and the product may also be referred to as a partially calcined kaolin. Further heating to temperatures above about 900-950° C. results in further structural changes such as densification. Calcination at these higher temperatures is commonly referred to as being full calcination and the product may be referred to as fully calcined kaolin. Additional calcination may cause formation of mullite, which is a very stable aluminium silicate phase.

Methods for making metakaolin are established and known to those skilled in the art. The furnace, kiln, or other heating apparatus used to effect calcining of the hydrous kaolin may be of any known kind. Calcination of the hydrous kaolin may take place, for example, in an oxidising atmosphere. A typical procedure may involve heating kaolin in a kiln, for example, in a conventional rotary kiln. According to some embodiments, the kaolin may be introduced into the kiln as an extrudate from a mill, such as, a pug mill. As the kaolin proceeds through the kiln, it may have a starting moisture content of about 25% by weight to facilitate the extrusion of the kaolin, and the extrudate may then form into pellets as a result of the calcination process. A small amount of a binder may be added to the kaolin to provide “green strength” to the kaolin so as to prevent the kaolin from completely breaking down into powder form during the calcination process. The temperature within a kiln used to create metakaolin should be within a specified range, typically above about 850° C. but typically not greater than about 950° C. At approximately 950° C., amorphous regions of metakaolin begin to re-crystallize.

The period of time for calcination of kaolin to produce metakaolin is based upon the temperature in the kiln to which the kaolin is subjected. Generally, the higher the temperature, the shorter the calcination time, and conversely, the lower the temperature, the higher the calcination time.

The calcination process may include soak calcining in which the hydrous kaolin or clay is calcined for a period of time during which the chemistry of the material is gradually changed by the effect of heating. The soak calcining may be for a period of, for example, at least 1 minute, at least 10 minutes, at least 30 minutes, at least 1 hour, or more than 5 hours. Known devices suitable for carrying out soak calcining may include high temperature ovens, rotary kilns, and vertical kilns. Alternatively, the calcination process may include flash calcining, in which the hydrous kaolin is typically rapidly heated over a period of less than one second, such as, for example, less than about 0.5 seconds. Flash calcination refers to heating a material at an extremely fast rate, almost instantaneously. The heating rate in a flash calciner may be of the order of about 56,000° C. per second or greater, such as about 100,000° C. per second, or about 200,000° C. per second. According to some embodiments, metakaolin may be prepared by flash calcination, wherein the kaolin clay may be exposed to a temperature greater than about 500° C. for a time not more than about 5 seconds. The clay may be calcined to a temperature in the range of from about 550° C. to about 1200° C. According to some embodiments, the temperature may be as high as about 1500° C. for microsecond periods. According to some embodiments, the kaolin clay may be calcined to a temperature in the range of from about 800° C. to about 1100° C., such as, for example, from about 900° C. to about 1050° C., or from about 950° C. to about 1000° C. The clay may be calcined for a time less than about 5 seconds, such as, for example, less than 1 second, less than 0.5 seconds, less than about 0.2 seconds, or less than 0.1 second. Flash calcination of kaolin particles gives rise to relatively rapid blistering of the particles caused by relatively rapid dehydroxylation of the kaolin. Water vapor is generated during calcination which may expand extremely rapidly, generally faster than the water vapor can diffuse through the crystal structure of the particles. The pressures generated are sufficient to produce sealed voids as the interlayer hydroxyl groups are driven off, and it is the swollen interlayer spaces, voids, or blisters between the kaolin platelets which typify flash calcined kaolins.

According to some embodiments, the method may be performed without adding water to the granulator separate from the slurry. It is believed that in some embodiments, the slurry may provide sufficient water to create a composition sufficient for granulation. This may improve the overall flow and efficiency of a proppant-making process. According to some embodiments, the method may include adding water to the granulator prior to granulating the dry ceramic powder and the slurry.

According to some embodiments, the granulator may be any type of granulation device, such as, for example, an Eirich mixer, a pan pelletizer, or a pin mill.

According to some embodiments, the slurry may include a recycled proppant material. As use herein, the term “recycled proppant material” refers to proppant material that was segregated or set aside from a previous manufacturing process. For example, the recycled proppant material may include a fired (e.g., sintered or calcined) recycled proppant material. Examples of fired recycled proppant material include, but are not limited to, proppant particles that were fired from green bodies and screened after the firing process. Fired recycled proppant materials may include, for example, undersized fired particles and/or oversized fired particles formed during calcination or firing of the green proppants. According to some embodiments, the fired recycled proppant material may include fines from particles that were crushed or ground during processing. The recycled proppant material may include a green recycled proppant material. A green recycled proppant material may include, for example, green (e.g., unfired or unsintered) proppant particles such as those from a granulator, that have been screened or milled. Examples of green recycled proppant particles may include undersized granules or oversized granules that were segregated during manufacturing. According to some embodiments, the recycled proppant material may include oversized ceramic particles, undersized ceramic particles, or both. Selection of oversized or undersized particles may be performed, for example, by conventional screening methods or by classification methods, such as, for example, a hydrocyclone. According to some embodiments, the recycled proppant material may include a milled recycled proppant material, such as, for example, fired or green particle that has been milled to provide a desired size distribution. The recycled proppant material may have been optionally screened to narrow its particle size distribution. When oversized and undersized particles are used to form the slurry, the resulting slurry may have a multimodal particle size distribution, such as, for example, a bimodal particle size distribution resulting from one mode corresponding to the undersized particles and one mode corresponding to the oversized particles.

Without wishing to be bound by a particular theory, it is believed that the use of a recycled proppant material may improve the densification of proppant particles. For example, when oversized and undersized particles are used, the undersized particles may fill interstitial voids between the oversized particles, resulting in a greater packing density, which may increase the bulk density or apparent density of the finished proppants.

According to some embodiments, the slurry may include a solids component of the slurry is a different material from the dry ceramic precursor material. For example, the dry ceramic precursor material may include an unfired clay material, such as kaolin, and the slurry may include a fired version of the same material, such as, for example, sintered or calcined kaolin. For example, the dry ceramic precursor may include kaolin and the slurry may include metakaolin. According to some embodiments, the dry ceramic precursor may include a metakaolin and the slurry may include a fired proppant material, such as, for example, undersized or oversized proppants from a screening operation or fines from proppant processing. In other embodiments, the dry ceramic precursor may include a ceramic precursor, such as, for example, powdered alumina, and the slurry may include a hydrous material, such as kaolin or green granules.

According to some embodiments, the slurry may have a solids content ranging from about 10 wt % to about 80 wt % of the slurry, such as, for example, ranging from about 10 wt % to about 50 wt %, ranging from about 50 wt % to about 80 wt %, ranging from about 30 wt % to about 70 wt %, ranging from about 35 wt % to about 65 wt %, ranging from about 10 wt % to about 30 wt %, ranging from about 20 wt % to about 40 wt %, ranging from about 40 wt % to about 60 wt %, ranging from about 30 wt % to about 40 wt %, ranging from about 35 wt % to about 45 wt %, ranging from about 40 wt % to about 50 wt %, ranging from about 45 wt % to about 55 wt %, ranging from about 50 wt % to about 60 wt %, ranging from about 55 wt % to about 65 wt %, ranging from about 60 wt % to about 80 wt %, ranging from about 60 wt % to about 70 wt %, or ranging from about 70 wt % to about 80 wt/p of the slurry. As used herein the solid content of the slurry refers to the weight of the insoluble material relative to the weight of the water in the slurry.

According to some embodiments, the dry ceramic precursor may include a binder. According to some embodiments, the slurry may include a binder. The slurry may include a binder, for example, when the insoluble material is a green or unfired composition that contains a binder, or a binder may be separately added to the slurry apart from the insoluble material. Exemplary binders or binding agents may include, for example, methyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulphonates, phosphates, alginates, and combinations thereof. Some possible solvents may include, for example, water, alcohols, ketones, aromatic compounds, and hydrocarbons.

The strength of a proppant may be indicated from a proppant crush resistance test described in ISO 13503-2: “Measurement of Properties of Proppants Used in Hydraulic Fracturing and Gravel-packing Operations.” In this test, a sample of proppant is first sieved to remove any fines (i.e., undersized pellets or fragments that may be present), then placed in a crush cell where a piston is then used to apply a confined closure stress of some magnitude above the failure point of some fraction of the proppant pellets. The sample is then re-sieved and the weight percent of fines generated as a result of pellet failure is reported as percent crush. A comparison of the percent crush of two equally sized samples is a method of gauging the relative strength of the two samples.

According to some embodiments, the ceramic proppant may have an ISO crush resistance of less than or equal to about 10% fines at 10,000 psi, such as, for example, less than or equal to about 9.5% fines, less than or equal to about 9.0% fines, less than or equal to about 8.8% fines, less than or equal to about 8.6% fines, less than or equal to about 8.5% fines, less than or equal to about 8.3% fines, less than or equal to about 8.2% fines, less than or equal to about 8.1% fines, or less than or equal to about 8.0% fines, less than or equal to about 7.5% fines, less than or equal to about 7% fines, less than or equal to about 6.5% fines, less than or equal to about 6% fines, or less than or equal to about 5.5% fines at 10,000 psi.

According to some embodiments, the ceramic proppant may have a sphericity greater than or equal to about 0.6, such as, for example, greater than or equal to about 0.65, greater than or equal to about 0.7, greater than or equal to about 0.75, greater than or equal to about 0.8, greater than or equal to about 0.85, greater than or equal to about 0.9, greater than or equal to about 0.91, greater than or equal to about 0.92, greater than or equal to about 0.93, greater than or equal to about 0.94, or greater than or equal to about 0.95.

According to some embodiments, the ceramic proppant may have a roundness greater than or equal to about 0.6, such as, for example, greater than or equal to about 0.91, greater than or equal to about 0.92, greater than or equal to about 0.93, greater than or equal to about 0.94, or greater than or equal to about 0.95.

According to some embodiments, the ceramic proppant may have an apparent specific gravity greater than or equal to about 1.50, greater than or equal to about 1.60, greater than or equal to about 1.70, greater than or equal to about 1.80, greater than or equal to about 1.90, greater than or equal to about 2.0, greater than or equal to about 2.10, greater than or equal to about 2.20, greater than or equal to about 2.30, greater than or equal to about 2.40, greater than or equal to about 2.50, greater than or equal to about 2.60, greater than or equal to about 2.70, greater than or equal to about 2.71, greater than or equal to about 2.72, greater than or equal to about 2.73, greater than or equal to about 2.74, greater than or equal to about 2.75, greater than or equal to about 2.76, or greater than or equal to about 2.77.

According to some embodiments, the ceramic proppant may have a density ranging from about 1.50 g/cc to about 2.90 g/cc. For example, the ceramic proppant may have an average apparent density ranging from about 1.50 g/cc to about 2.0 g/cc, ranging from about 1.80 g/cc to about 2.80 g/cc, ranging from about 2.0 g/cc to about 2.90 g/cc, ranging from about 2.40 g/cc to about 2.9 g/cc, ranging from about 2.50 g/cc to about 2.85 g/cc, ranging from about 2.6 g/cc to about 2.85 g/cc, ranging from about 2.75 g/cc to about 2.85 g/cc, ranging from about 2.70 g/cc to about 2.80 g/cc, ranging from about 2.71 g/cc to about 2.77 g/cc, ranging from about 2.71 g/cc to about 2.75 g/cc, or ranging from about 2.72 g/cc to about 2.74 g/cc.

According to some embodiments, the ceramic proppant may have bulk density greater than or equal to about 1.54 g/cc. For example, the ceramic proppant may have a bulk density greater than about 1.55 g/cc, greater than about 1.56 g/cc, greater than about 1.57 g/cc, or greater than about 1.58 g/cc.

According to some embodiments, the slurry may include a solids content in which greater than or equal to about 60% by weight of the particles have a particle size greater than or equal to about 600 μm (30 mesh) and less than or equal to about 1200 μm (16 mesh), such as, for example, greater than or equal to about 65% by weight of the particles have a particle size greater than or equal to about 600 μm (30 mesh) and less than or equal to about 1200 μm (16 mesh).

According to some embodiments, the slurry may include a solids content in which greater than or equal to about 30% by weight of the particles have a particle size greater than or equal to about 400 μm (40 mesh) and less than or equal to about 840 μm (20 mesh), such as, for example, in which greater than or equal to about 35% by weight of the particles have a particle size greater than or equal to about 400 μm (40 mesh) and less than or equal to about 840 μm (20 mesh).

According to some embodiments, the slurry may include a solids content in which greater than or equal to about 30% by weight of the particles have a particle size greater than or equal to about 400 μm (40 mesh) and less than or equal to about 840 μm (20 mesh), such as, for example, in which greater than or equal to about 35% by weight of the particles have a particle size greater than or equal to about 400 μm (40 mesh) and less than or equal to about 840 μm (20 mesh).

According to some embodiments, the slurry may include a solids content in which greater than or equal to about 90% by weight of particles having a particle size greater than or equal to about 150 μm (100 mesh), such as, for example, in whichgreater than or equal to about 95% by weight, greater than or equal to about 96% by weight, greater than or equal to about 97% by weight, greater than or equal to about 98% by weight, or greater than or equal to about 99% by weight having a particle size greater than or equal to about 150 μm (100 mesh).

According to some embodiments, the slurry may include a solids content in which greater than or equal to about 90% by weight of particles having a particle size less than or equal to about 100 μm (140 mesh), such as, for example, in which greater than or equal to about 95% by weight, greater than or equal to about 96% by weight, greater than or equal to about 97% by weight, greater than or equal to about 98% by weight, or greater than or equal to about 99% by weight having a particle size less than or equal to about 100 μm (140 mesh).

According to some embodiments, the dry ceramic precursor may be sized using various milling or grinding techniques, including, for example, attrition grinding and autogenous grinding (i.e., grinding without a grinding medium), and may be ground either by a dry grinding or a wet grinding process. When the dry ceramic precursor is subjected to a wet grinding process, the resulting material may be dried before it is mixed with the slurry. The grinding may be accomplished by a single grinding step or may involve more than one grinding step.

Proper sizing prior to forming the proppants can increase the compacity of the feed and ultimately result in a stronger proppant or anti-flowback additive. In some embodiments, a jet mill may be used to prepare a first batch of particles having a first particle size distribution. In a jet mill, the particles are introduced into a stream of fluid, generally air, which circulates the particles and induces collisions between the particles. Using known techniques, the forces in the jet mill can alter the particle size distribution of the particles to achieve a desired distribution. For example, one may vary the type of fluid used in the mill, the shape of the milling chamber, the pressure inside the mill, the number and configuration of fluid nozzles on the mill, and whether there is a classifier that removes particles of a desired size while leaving others in the mill for additional milling. The exact configuration will vary based on the properties of the feed material and the desired output properties. The appropriate configuration for a given application can be readily determined by those skilled in the art.

In some embodiments, the dry ceramic precursor or solids component of the slurry may have a multimodal distribution of particles. According to some embodiments, a multimodal distribution may be created by jet milling more than one batch of particles and mixing the particles together. A multimodal distribution may optionally be sized in a ball mill. Similar to jet milling multiple batches to different particle sizes and mixing them, ball milling may result in a multimodal particle size distribution, which can improve the compacity of the powder. In contrast to a jet milling process, however, acceptable results may be achieved in a single ball-milled batch of particles (i.e., there is no requirement to prepare multiple batches and mix them). Of course, there is no technical reason to avoid combining multiple ball-milled batches, and some embodiments may involve ball milling multiple batches (or using other milling means) and mixing them to form a powder with a desired multimodal particle size distribution. In some embodiments, batches with two different particle size distributions can be simultaneously milled in the ball mill, resulting in a powder with a multimodal particle size distribution.

Mechanically, a ball mill contains a chamber in which the ceramic precursor and a collection of balls collide with each other to alter the precursor material's particle size. The chamber and balls are typically made of metal, such as aluminum or steel. The appropriate configuration for the ball mill (e.g., the size and weight of the metal balls, the milling time, the rotation speed, etc.) can be readily determined by those skilled in the art. The ball milling process can be either a batch process or a continuous process. Various additives may also be used to increase the yields or efficiency of the milling. The additives may act as surface tension modifiers, which may increase the dispersion of fine particles and reduce the chance that the particles adhere to the walls and ball media. Suitable additives are known to those skilled in the art and include aqueous solutions of modified hydroxylated amines and cement admixtures. In some embodiments, the ball mill may be configured with an air classifier to reintroduce coarser particles back into the mill for a more accurate and controlled milling process.

Without wishing to be bound by a particular theory, it is believed that the use a slurry in place of water, or in addition to water, during granulation may increase the solids content of the granulated composition. By increasing the solids content of the granules, packing density may be improved, resulting in denser and/or mechanically stronger proppants after firing (e.g., heating or sintering).

When the slurry composition includes a recycled proppant material, whether a green recycled proppant material, a fired recycled proppant material, combination thereof, or any other form of recycled proppant material, it is believed that the efficiency of the proppant manufacturing process may be improved by the use of a slurry. For example, the use of a slurry may allow for the addition of a greater weight percent of proppant precursor (either in green form or in fired form, such as, for example, sintered or calcined form) to be included in the granulation mixture. The use of a slurry may also allow for certain types of particles, such as green or fired oversized or undersized particles, to be re-incorporated into the granulation process, thereby improving the utility of these particles and the overall efficient use of the materials.

According to some embodiments, the proppants described in this disclosure may be used by themselves to create a proppant pack. According to some embodiments, the proppants described in this disclosure may be used in conjunction with other proppant particles as part of a proppant pack.

### Example 1

A slurry of 50 wt % metakaolin was prepared by placing 1000 grams of water in a beaker, adding 1000 grams of metakaolin, and mixing to create the slurry. A typical chemical composition for the metakaolin is shown below in Table 1.

TABLE 1

| (Calcined basis) | Percent (%) |
|---|---|
| Al₂O₃ | 45.5 |
| SiO₂ | 51.1 |
| Fe₂O₃ | 0.96 |
| CaO | 0.05 |
| TiO₂ | 1.86 |
| MgO | 0.07 |
| Na₂O | 0.07 |
| K₂O | 0.17 |
| Moisture and loss on | 2.00 |
| ignition at 2000° F. | |

The pH of the slurry was adjusted to pH 9 by adding sodium hydroxide. The viscosity of the slurry was measured using a Brookfield viscometer and was 295 cps.

A control proppant (“Control”) was prepared by placing 3000 grams of the metakaolin in an Eirich mixer. 1000 grams of water with 15 grams of PVA was added to the metakaolin and mixed at 60 rpm for 5 minutes to prepare granulations.

A first proppant sample (sample A) was prepared by placing 2000 g of dry metakaolin in an Eirich mixer. 1575.7 grams of the 50 wt % slurry was added to the metakaolin. The resulting slurry-metakaolin composition was mixed at 60 rpm for 5 minutes. After adding the slurry, 185 grams of water and 15 grams of PVA were added to the mixture. The resulting composition was mixed at 60 rpm for 5 minutes to prepare granulations. The total moisture content of the granulated sample A was about 26 wt % based on the total metakaolin content of 2787.9 grams and the total water content of about 972.9 grams.

A second proppant sample (sample B) was prepared by placing 3000 grams of dry metakaolin in an Eirich mixer. 2412.6 grams of the 50 wt % slurry was added to the metakaolin. The slurry-metakaolin composition was mixed at 60 rpm for 5 minutes. After adding the slurry, 357 grams of water and 15 grams of PVA. The resulting composition was mixed at 60 rpm for 5 minutes to prepare granulations. The total moisture content of granulated sample B was determined to be about 26 wt % based on the total metakaolin content of 4206.3 grams and the total water content of about 1563.3 grams.

A third proppant sample (sample C) was prepared in the same way as sample B, except that the water and 30 grams of PVA was added to the 50 wt % slurry prior to mixing the slurry with the dry metakaolin. Thus, for sample C only one addition of moisture was added to the dry metakaolin. The resulting mixture was mixed at 60 rpm for 5 minutes to prepare granulations. The total moisture content of sample C was about 26 wt %, as in sample B.

Samples A-C and the control sample were then fired for 1 hour at the various temperatures shown in Table 2. The pellet “crush strength” and the specific gravity of each sample and the control was measured, the results of which are shown in Table 2. The crush strength and specific gravity is shown in Table 2.

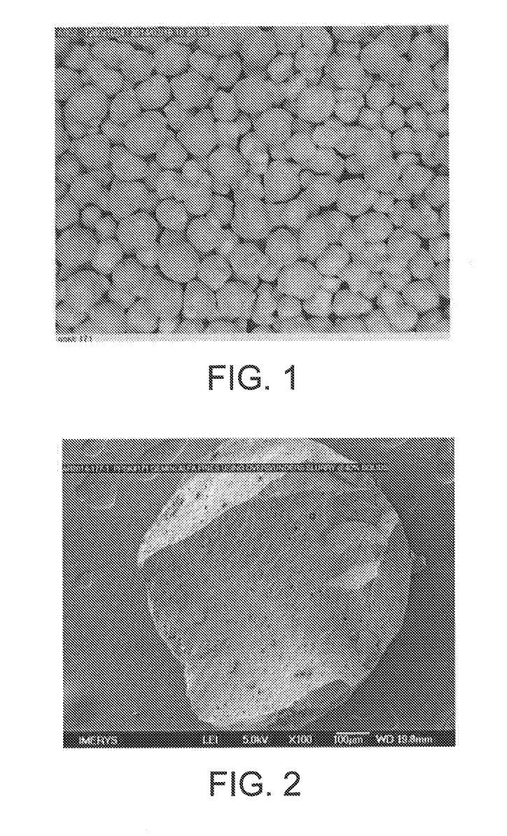

“Crush strength” tests were performed on each of the samples. In this test, 10 to 20 pellets were placed on a flat surface and compressed with another flat surface until they failed. The force exerted was noted, as well as the diameters of the pellets. The force withstood was then normalized and converted into a compressive pressure by dividing the force by the cross-sectional area of the pellets. The results, which indicate what we refer to in this application as “crush strength,” are shown below in Table 1 and FIG. 1. In some instances, multiple tests were performed, and the table reflects the average results of those tests.

TABLE 2

| | Firing Temp. | Crush Strength | |
|---|---|---|---|
| Sample | (° C.) | (MPa) | Specific Gravity |
| Control | 1400 | 124 | 2.61 |
| | 1450 | 195 | 2.61 |
| | 1500 | 198 | 2.69 |
| | 1550 | 146 | 2.69 |
| | 1600 | 249 | 2.68 |
| Sample A | 1300 | 87 | 2.71 |
| | 1400 | 148 | 2.73 |
| | 1450 | 151 | 2.7 |
| | 1500 | 166 | 2.7 |
| | 1550 | 223 | 2.69 |
| | 1600 | 234 | 2.7 |
| Sample B | 1300 | 115 | 2.73 |
| | 1400 | 177 | 2.73 |
| | 1450 | 160 | 2.7 |
| | 1500 | 201 | 2.7 |
| | 1550 | 218 | 2.71 |
| | 1600 | 239 | 2.7 |
| Sample C | 1300 | 124 | 2.72 |
| | 1400 | 255 | 2.7 |
| | 1450 | 199 | 2.74 |
| | 1500 | 200 | 2.73 |
| | 1550 | 284 | 2.74 |
| | 1600 | 267 | 2.73 |

As shown in Table 2, the specific gravity of each of samples A-C, prepared using the slurry addition, was higher than the control sample, which was prepared with only water. Furthermore, for nearly all firing temperatures above 1400° C., the crush strength of samples A-C appears to be comparable to or even greater than the control sample. At 1600° C., the crush strength for all of the samples A-C and the control were relatively similar, with sample C being slightly higher than samples A and B and the control. This suggests that using a slurry instead of, or in addition to, water when preparing the granulations may result in comparable or even improved mechanical properties, such as crush strength, when compared with a proppant prepared from a dry ceramic precursor and water alone. The data also suggests that a proppant prepared using a slurry instead of, or in addition to, water when preparing the granulations may also improve densification of the proppants (e.g., they may have a higher specific gravity and density). The examples also show that a binder can be incorporated into the slurry prior to adding the slurry to the dry powder, as in sample C, while still achieving comparable or improved properties.

Without wishing to be bound by a particular theory, it is believed that the addition of a slurry instead of only water adds extra mineral to the resulting mixture, thereby increasing the bulk density. The slurry may also improve the packing of the inorganic materials during granulation when compared to the dry powder and water. This improved packing may result in a denser granulation bead and a denser proppant after firing.

It was surprisingly found that using a slurry instead of, or in addition to, water when preparing the granulations substantially improved the output of each granulation. Based on this finding, the use of a slurry may also improve the yield of various proppant preparation methods.

### Example 2

A sample proppant prepared with fine particles was prepared using fine metakaolin particles by placing 2403 grams of the fine particles in an Eirich mixer and adding 756 grams of water. The resulting composition was mixed for 5 minutes at 32 rpm. The resulting granules had a moisture content of 23.2 wt %. The granules were then fired at 1500° C. for 3 hours.

Three additional proppant samples, D-F, were prepared by mixing green screen oversized pellets and undersised pellets into three separate slurries with water comprising 38.2 wt % (sample D), 50.0 wt % (sample E), and 55.0 wt % (sample F) of the slurries. The oversized pellets and undersized pellets were mixed into the slurries without pre-screening before being made into a slurry. The chemical composition of the slurries was determined by x-ray fluorescence (XRF) and is shown below in Table 3.

TABLE 3

| Overs + Unders | Percent (%) |
|---|---|
| Al₂O₃ | 49.03 |
| SiO₂ | 46.49 |
| Fe₂O₃ | 0.87 |
| CaO | 0.04 |
| TiO₂ | 2.10 |
| MgO | 0.08 |
| Na₂O | 0.06 |
| K₂O | 0.03 |
| P₂O₅ | 0.04 |
| Moisture and loss on | 4.15 |
| ignition at 2000° F. | |

0.2 wt % of PVA was added to each slurry sample as a binder.

To prepare sample D (38.2 wt % slurry), 2403 grams of fines were added to an Eirich mixer. 1420 grams of the 38.2 wt % slurry with PVA was added to the dry fines and mixed for 5 minutes at 32 rpm to granulate the sample. The moisture content of the resulting granules was 22.1 wt %.

Samples E and F were prepared in the same way as sample D, except that 50.0 wt % and 55.0 wt % slurries were used, respectively. The moisture contents of the granules prepared for samples E and F were 22.6 wt % and 21.4 wt %, respectively.

The granules from the fined and samples D-F were then fired at 1500° C. for 3 hours. The fired proppants were screened 20/40 fraction was crushed at 10,000 psi according to the ISO standard procedure. The bulk density of 20/40 fraction of the fired proppants was also measured. The results of the ISO crush test and bulk density measurements is shown below in Table 4. FIG. 1 shows an SEM micrograph of the proppants of sample D.

TABLE 4

| | ISO Crush Resistance at | Bulk Density |
|---|---|---|
| Sample | 10,000 psi (wt % fines) | (g/cm³) |
| Fines Control | 8.9 | 1.57 |
| Sample D | 8.2 | 1.56 |
| Sample E | 8.1 | 1.55 |
| Sample F | 5.5 | 1.57 |

As shown in Table 4, green oversized and undersized pellets can be used to form a slurry that may be added the dry proppant precursor powder to form a granulation composition. The use of a slurry in place of water appears to result in good quality proppants having an ISO crush resistance of less than 9 wt % fines. For example, samples D and E have about 8 wt % fines at 10,000 psi. Sample F resulted in only 5.5 wt % fines at 10,000 psi.

FIG. 2 shows a proppant of sample D, showing the low internal porosity of the proppant.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of making a ceramic proppant, the method comprising:
adding a dry ceramic precursor to a granulator;
adding a slurry to the granulator;
granulating the dry ceramic precursor and the slurry to form densified granules; and
firing the densified granules to form a ceramic proppant.

2. The method of claim 1, wherein the dry ceramic precursor comprises an alumina- or aluminosilicate-containing material.

3. The method of claim 2, wherein the alumina- or aluminosilicate-containing material comprises at least one of kaolin, ball clay, bauxitic kaolin, smectite clay, bauxite, gibbsite, boehmite, metakaolin, or diaspora.

4. The method of claim 1, wherein method is performed without adding water to the granulator separate from the slurry.

5. The method of claim 1, further comprising adding water to the granulator prior to granulating the dry ceramic precursor and the slurry.

6. The method of claim 1, wherein the granulator is selected from the group consisting of an Eirich mixer, a pan pelletizer, and a pin mill.

7. The method of claim 1, wherein the slurry comprises a recycled proppant material.

8. The method of claim 7, wherein the recycled proppant material comprises a fired recycled proppant material.

9. The method of claim 7, wherein the recycled proppant material comprises a milled recycled proppant material.

10. The method of claim 7, wherein the recycled proppant material comprises a green recycled proppant material.

11. The method of claim 7, wherein the recycled proppant material comprises oversized ceramic particles.

12. The method of claim 7, wherein the recycled proppant material comprises undersized ceramic particles.

13. The method of claim 1, wherein the slurry comprises a solids component that is a different material from the dry ceramic precursor material.

14. The method of claim 1, wherein the slurry has a solids content ranging from about 40 wt % to about 60 wt %.

15. The method of claim 1, wherein the dry ceramic precursor further comprises a binder.

16. The method of claim 1, wherein the ceramic proppant has an ISO crush resistance of less than or equal to about 9% fines at 10,000 psi.

17. The method of claim 1, wherein the ceramic proppant has an apparent specific gravity greater than or equal to about 2.7 g/cc.

18. The method of claim 1, wherein the ceramic proppant has a sphericity greater than or equal to about 0.9.

19. The method of claim 1, wherein the ceramic proppant has a roundness greater than or equal to about 0.9.
